(19) United States
(12) Patent Application Publication
(10) Pub. No.: US 2017/0200238 A1
(43) Pub. Date: Jul. 13, 2017

(54) AGGREGATION OF BIDS FROM MULTIPLE ENERGY PROVIDERS

(71) Applicant: Avion Energy, Inc., Lawrenceville, GA (US)

(72) Inventors: Jacqueline Burdette, Chicora, PA (US); James P. Charron, Lawrenceville, GA (US); Brett Kettlewell, Snellville, GA (US)

(73) Assignee: Avion Energy, Inc.

(21) Appl. No.: 14/991,384

(22) Filed: Jan. 8, 2016

(51) Int. Cl. G06Q 50/06; G06Q 30/04

(52) U.S. Cl. CPC G06Q 50/06; G06Q 30/04

(57) ABSTRACT

A computerized energy broker system filters to resolve a plurality of energy providers deemed suitable to satisfy a customer request for energy supply; generates a request for pricing (RFP) corresponding to the customer request and distributes the RFP to each of the plurality of energy providers. Each bid received in response to distributing the RFP is entered and the energy brokerage system normalizes the received bids so as to reflect a common unit of measure and at least one common term of contract. It then aggregates the normalized received bids into an aggregated price comparison sheet that identifies each of the energy providers from which a bid was received with corresponding price according to the common unit of measure and the at least one common term of contract. The aggregated price comparison sheet is communicated from the energy broker system to a customer associated with the customer request.

### TECHNOLOGICAL FIELD

The described invention relates to brokering products and services offered by multiple energy providers for commercial and/or residential customers on a customized basis, and particularly providing a direct comparison of the offered products/services.

### BACKGROUND

Deregulation of electricity and natural gas supply and delivery to end customers has left a complex patchwork of differing rules and regulations that energy brokers must navigate, particularly when serving customers in different states and utilities. These different energy markets themselves are dissimilar in important aspects; delivery of natural gas was first deregulated in 1981 while that of electricity began in 1992 with further major changes in 2005. Consequently, the implementation of deregulation for electricity and natural gas is governed by each state individually and hereinafter the state regulatory body relevant to end-customer sales of electricity and natural gas will be referred to as the state's Public Utility Commission (PUC) though in fact the regulatory body may be known by different names in different states. In general state PUCs are tasked with setting rules and processes for transitioning the provisioning of natural gas and/or electricity from a monopolistic system to a competitive one.

Prior to deregulation a utility company built the infrastructure to deliver energy—electricity through the power grid and/or natural gas through pipelines. Metering devices at end-user premises quantify the amounts used for billing purposes. The utility companies continue to maintain this infrastructure as the energy delivery mechanism, and so the delivery of electricity and natural gas to end users entails both the product (electricity and natural gas) and the service (using the delivery infrastructure). Typically even in deregulated markets the state PUC sets rates for the public utility company's delivery services as well as for its supply of energy distinct from its delivery.

Thus in deregulated markets it is the energy product, the supply of energy itself whether electricity or natural gas, that is subject to competition and customer choice. Third-party energy providers can generally price their energy product without regard to the PUC's supply rate which binds only the public utility. These third party providers then deliver enough electricity or natural gas to the central metering point of the public utility company to satisfy the consumption needs of each and every one of their own energy consumers. But individual customer's actual energy needs are seldom precisely known in advance and so there is a continual balancing process between the utility company and the third-party energy providers. In most cases there are different rules for this balancing according to the different rate classes of the various consumers, whether residential, small business, commercial, industrial, etc. Often the third party energy providers secure their own supply of electricity and natural gas via the commodities markets (NYMEX, NGI, etc.) where prices change very frequently.

In some service areas the end-user customers can choose from among a dozen or more energy providers, only one of which might be the public utility offering the PUC-mandated supply rates. A 2015 study that assumed 67% of electricity sales are subject to regulated average-cost pricing while the remaining 33% are priced competitively shows that about ⅔ of the retail price of electricity is due to generation (including generation costs and retail taxes) and the remainder is attributable to transmission and distribution costs.

For customers to make an informed choice among the various third party energy providers is often a time consuming endeavor; there is an information deficit customers must overcome by educating themselves more thoroughly about energy contracts; offerings from different third party energy providers are seldom subject to direct apples-to-apples comparison; and customers seldom know the world of third party energy providers servicing their area. Energy brokers have filled the resulting information-gap that customers experience in making sense of the different offerings by the different energy suppliers, though it is true that some brokers represent only one of the energy suppliers. Of the 15 US states that currently have deregulated electricity and/or natural gas supply markets, 9 of them plus the District of Columbia require some registration or licensure of the energy brokers. But energy contracts at least for high volume business and industrial customers are highly customized and so these highly trained brokers can typically work only 3-4 deals per workday. This is one reason energy brokers typically operate in only limited markets. What is needed in the art is a way to automate the process of gathering the relevant customer information, soliciting offerings from suitable third party energy providers, presenting to the customer a comparison of the solicited offers in a manner that they are directly comparable to one another, and obtaining a contract from the customer for one of the offers.

In the field of automating brokered services, Progressive Casualty Insurance Company has shown comparative insurance pricing to customers since about 1995; Expedia® and Travelocity® have gathered online quotes from airlines and hotels and presented them to customers in a side-by-side comparison since about 1996, and LendingTree® has returned to customers loan offerings from different banks since about 1998. While relevant, none of these are directly adaptable to automating the brokering of energy supplies for delivery to customer premises.

### SUMMARY

According to a first aspect of these teachings there is a method for operating a computerized energy broker system. In this aspect the method comprises: filtering with the energy broker system to resolve a plurality of energy providers deemed suitable to satisfy a customer request for energy supply; generating with the energy broker system a request for pricing (RFP) corresponding to the customer request and distributing the RFP to each of the plurality of energy providers; entering into the energy brokerage system each bid received from each of the plurality of energy providers in response to distributing the RFP; normalizing by the energy broker system the received bids so as to reflect a common unit of measure and at least one common term of contract; aggregating by the energy broker system the normalized received bids into an aggregated price comparison sheet that identifies each of the plurality of energy providers from which a bid was received with corresponding price according to the common unit of measure and the at least one common term of contract; and communicating the aggregated price comparison sheet from the energy broker system to a customer associated with the customer request.

According to a second aspect of these teachings there is a computer readable memory tangibly storing computer program code that when executed by one or more processors causes a host device to at least: filter to resolve a plurality of energy providers deemed suitable to satisfy a customer request for energy supply; generate a request for pricing (RFP) corresponding to the customer request and distributing the RFP to each of the plurality of energy providers; enter each bid received from each of the plurality of energy providers in response to distributing the RFP; normalize the received bids so as to reflect a common unit of measure and at least one common term of contract; aggregate the normalized received bids into an aggregated price comparison sheet that identifies each of the plurality of energy providers from which a bid was received with corresponding price according to the common unit of measure and the at least one common term of contract; and communicate the aggregated price comparison sheet to a customer associated with the customer request.

According to a third aspect of these teachings there is a computing device such as a server comprising at least one memory storing computer program code; and at least one processor. In this aspect the at least one processor is configured, with the at least one memory and the computer program code, to cause the computing device to at least: filter to resolve a plurality of energy providers deemed suitable to satisfy a customer request for energy supply; generate a request for pricing (RFP) corresponding to the customer request and distributing the RFP to each of the plurality of energy providers; enter each bid received from each of the plurality of energy providers in response to distributing the RFP; normalize the received bids so as to reflect a common unit of measure and at least one common term of contract; aggregate the normalized received bids into an aggregated price comparison sheet that identifies each of the plurality of energy providers from which a bid was received with corresponding price according to the common unit of measure and the at least one common term of contract; and communicate the aggregated price comparison sheet to a customer associated with the customer request.

### BRIEF DESCRIPTION OF THE DRAWINGS

FIG. 1 is a schematic diagram illustrating at a high level an exemplary process flow from initial customer contact to signed energy supply contract according to certain embodiments of these teachings.

FIG. 2 is a schematic block diagram of a customer relationship management (CRM) module of the overall integrated energy broker system according to certain exemplary embodiments of these teachings.

FIG. 3 is a schematic diagram of an integrated energy broker system according to exemplary embodiments of these teachings, which includes the CRM module of FIG. 2.

FIG. 4 is an example of an aggregated price comparison sheet generated by the integrated energy broker system of FIG. 3, according to an exemplary embodiment of these teachings.

FIG. 5 is a process flow diagram summarizing some of the steps described above that are performed by or with the integrated energy broker system according to an exemplary embodiment of these teachings.

FIG. 6 is a high level schematic block diagram illustrating certain apparatus/devices that are suitable for practicing certain of these teachings.

### DETAILED DESCRIPTION

Unlike brokerage or price aggregator services in other fields, in the arena of electrical and natural gas supply the providers of such supply generally do not make their price quotes available online, particularly for non-residential customers. Such energy providers typically provide third party price quotes only to brokers with whom they have what is known as a Channel Partner Agreement, and it is typical that most energy suppliers limit the number of Channel partner Agreements they will have outstanding at any given time. Energy providers that are not public utilities only provide price quotes on prospective contracts to brokers with whom they have a current Channel Partner Agreement.

Generally, energy providers do not provide dynamic energy pricing online in a generically searchable manner, particularly for commercial/industrial accounts. As will be seen below, embodiments of these teachings may have energy provider's pricing online in a dynamic (e.g., updated at least daily when commodity markets are open) customized quote that is valid for one individual customer and in that regard it may be searchable given access to the server on which those quotes might be stored, but it is specific to an individual customer and thus not generic to other customers in general. Price aggregations in other fields utilize online and publicly available airline ticket prices or loan interest rates for example to compile an aggregated price comparison for customer review.

Because the different energy suppliers are not providing their pricing online, often the quotes they provide are not uniform across different energy suppliers. While most electricity suppliers price in kilowatt-hours (kWh or similarly megawatt-hours MWh), some natural gas suppliers price per therm (100,000 British Thermal units BTUs, or similarly decatherms) while others in the same market price per CCF (one hundred cubic feet of gas, or similarly million cubic feet MCF). And these are only the base supply rates; different energy suppliers also impose different penalties and fees apart from uniform government taxes. Some energy suppliers quote in fixed rate, some in index rates, and some in block rates. Some include government taxes within their price quote while others do not, even in the same uniform taxation region or state. All of these must be taken into account in a per-unit pricing in order for the energy broker to provide his/her end-customers with a straightforward apples-to-apples comparison of the offerings from different energy suppliers.

The end product according to certain embodiments presented below is a pricing presentation matrix showing offers by different energy providers that are directly comparable to one another, such that each offer quoted to the customer in the matrix incorporates terms, rates, fees, taxes, and the like so that the customer need not become expert in the specialized linguistics of the energy supply industry in order to make an informed decision to enter into an energy supply contract that typically needs to be made only once a year or once every several years. By automating the process from gathering customer information to soliciting and aggregating bids, certain activities that took several hours in the past can now be completed in minutes.

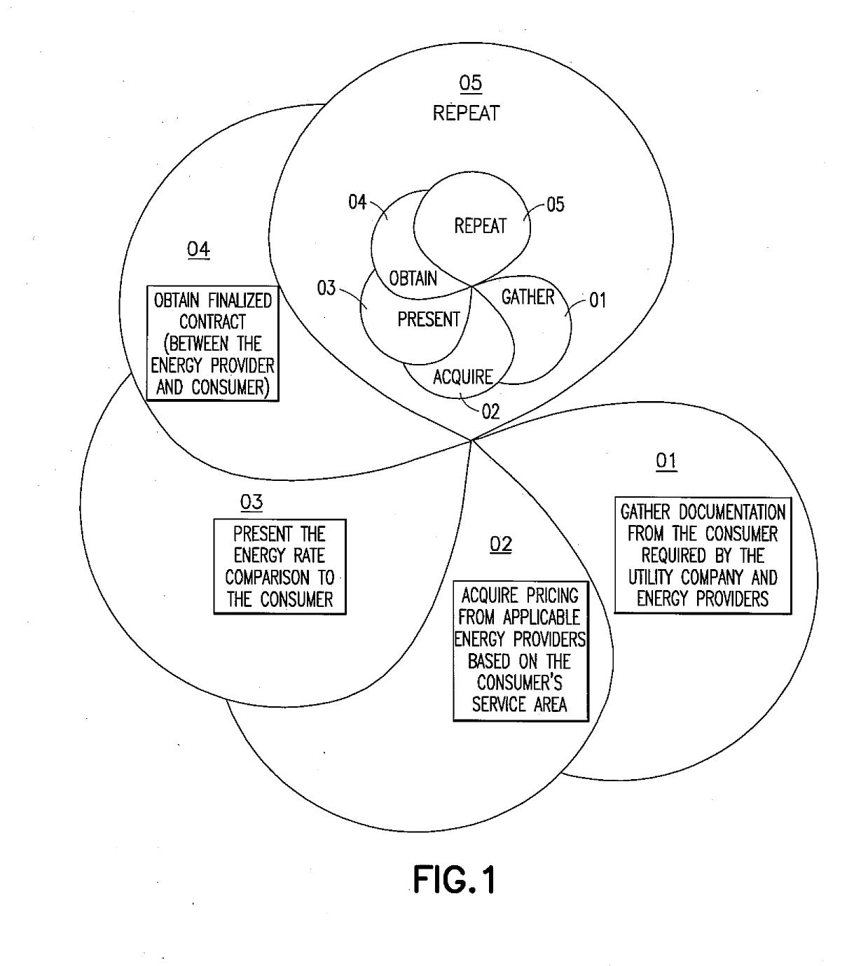

While presenting this information to the customer entails the majority of the broker's work, the signed contract from the customer is the end goal and so FIG. 1 shows a high level diagram of an efficient process flow from start to finish that is detailed further below. At step 01 the energy broker system gathers documentation from the consumer; typically this information is what is required by the utility company for delivery services and by the energy providers for providing the electricity or natural gas. At step 02 the energy broker system acquires pricing from applicable energy providers, and this is based on the consumer's service area as well as a variety of other individualized factors. The information gathered in step 02 is compiled, converted and aggregated by the energy broker system, which presents an Energy Rate Comparison to the consumer at step 03. Because the energy providers are often securing their supply via highly volatile commodity markets their price quotes are generally very short lived; typically one workday or less. Therefore step 04 where the energy brokerage system obtains from the customer a finalized contract for energy supply follows fairly quickly from step 03. The energy broker system can repeat at step 05 the previous four steps for other customers, in parallel or seriatim.

Additionally, the repeat step 05 also applies to this current customer when the end of its earlier contract term is nearing. For example, if a customer signs 12 month energy supply contract, previously that customer would be at a market disadvantage as that date approached because customers generally do not track their electricity or natural gas supply contract termination dates. If the customer has little time to find an alternate supplier they may be forced to renew with their current supplier at a rate markedly higher than competitive rates rather than suffer a temporary loss of supply. Certain embodiments of the energy broker system described herein automatically send a reminder to existing clients several weeks or months prior to the termination date of the existing contract, asking if the broker system should search again for energy suppliers for the customer. For example, if a customer signed a 12 month contract on December 15^{th} the broker system would send a reminder on October 15^{th} and any new pricing obtained for the customer would be predicated on initiating supply for this next 12 month contract on December 14^{th} or 15^{th}.

The entity operating the broker system is in certain embodiments paid on commission from the energy supplier, so no separate invoice goes to the customer. This commission is incorporated into the comparative price quotes presented to the customer at step 03 of FIG. 1. While the energy broker performs the vast majority of its services all at once leading up to contract signing at step 04, its commission is paid out by the customer-selected energy supplier over the course of the contract to better spread customer expenses. A given customer's prior year or years usage is pulled from the system's archived data (or entered into the system by the energy broker, for example with new customers), which is used to estimate energy quantity per month or other period over the course of the new contract. The energy supplier with whom the customer has the new energy supply contract reports the actual energy usage per customer, which is taken as inputs to the energy brokerage system for computing the broker's commission. But the energy broker system takes this commission computation further by comparing each customer's actual energy usage against the estimated usage per period, and flagging to the energy broker those accounts with unacceptable variances (after accounting for weather/temperature variations across the compared periods). This enables the energy broker to check if there are any usage reporting discrepancies by the energy provider, for example where the energy provider is providing energy to multiple meters/service locations for a given customer but not all of them are being included in the calculated actual usage being reported to the integrated energy broker system.

The energy supply industry may be considered to be segmented into three general consumer categories—Residential (R), Small/Medium Business (SMB), and Commercial/Industrial (CI). These are further divided by usage-specific rate classes in order to comply with regulations and consumer protections effecting the sales process, contract terms and conditions, etc. enacted by each state's legislature and PUC. As such, at least the CI segment is not amenable at this time to a one-size-fits-all price aggregation approach as is used for other products and services such as hotels, airline travel, car rentals and bank lending.

Commensurate with the energy broker registration/licensure mentioned above there are recordkeeping and quarterly/annual reporting requirements. The integrated energy broker system according to these teachings automatically archives solicitations, responses, quotes/proposals presented to customers, and related communications for these auditing and reporting purposes, and the quotes and related records are also searchable and aggregable by utility for financial reporting to the relevant PUCs.

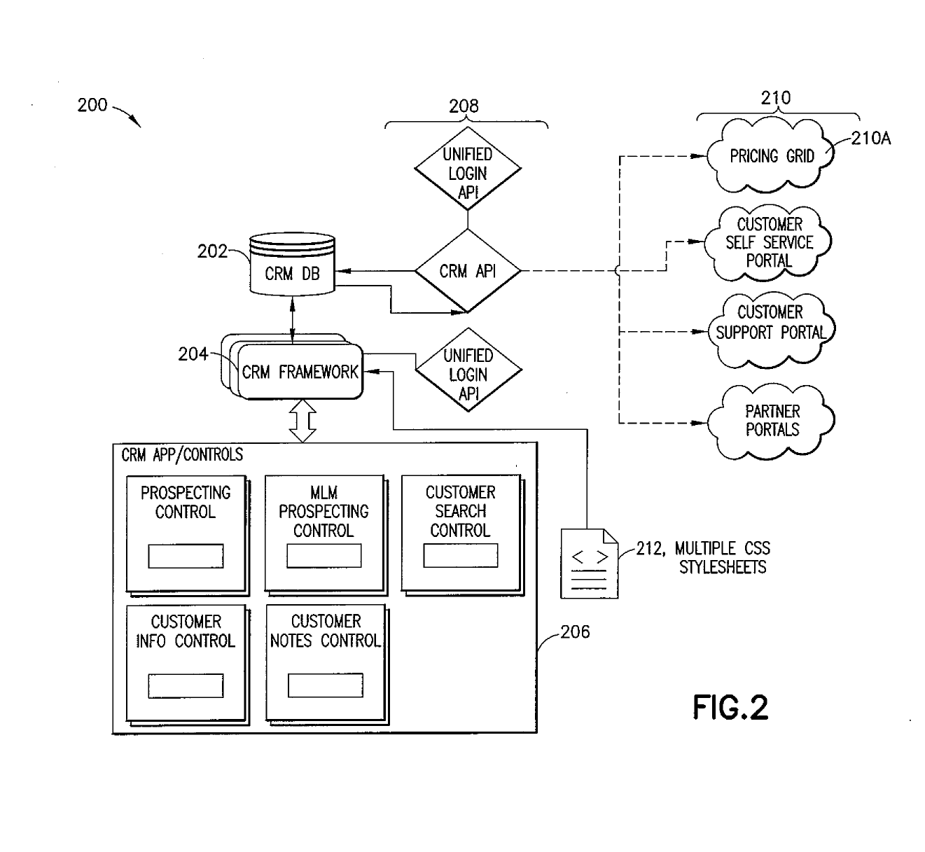

FIG. 2 is a schematic block diagram of the customer relationship management (CRM) module 200 of the integrated energy broker system. Much of the CRM module 200 incorporates conventional aspects of customer data management software adapted for the energy brokerage purposes described herein, except the pricing grid/matrix portal 210A as detailed further below is seen to be particularly different from conventional practice. The CRM database (DB) 202 holds all the relevant customer information gather from initial customer intake, as updated with energy contracts entered, contract termination date, and the like. The CRM framework 204 interfaces the CRM DB 202 with various CRM applications 206 by which sales agents and brokers can search for various customer information for marketing and contract servicing purposes. Various application programming interfaces (APIs) 208 enable customers, employees and energy supplier partners to access certain designated portions of the DRM DB 202 via their respective web portals 210. As is typical, embodiments of the integrated energy broker system may have a unified login API such as at the energy brokerage's home page that leads/links to other more specific APIs such as the CRM API shown at FIG. 2.

One such web portal is a pricing grid or matrix portal 210A that shows real-time or near real-time (e.g., updated at least once daily on days that commodity markets are open) energy pricing that may be used for basic research by certain smaller and shorter term customers such as residential and some small business customers for which non-customized energy contracts may be suitable. The pricing grid or matrix portal 210A provides automated and localized matrix/daily pricing across a large pool of energy suppliers/providers for residential and certain small business customers. This portal 210A will gather input from the energy consumers, either directly or via the customer self-service portal, to determine his/her geographic utility area, and perform the real-time poll of the partnering energy suppliers/providers to provide several pricing options for these consumers.

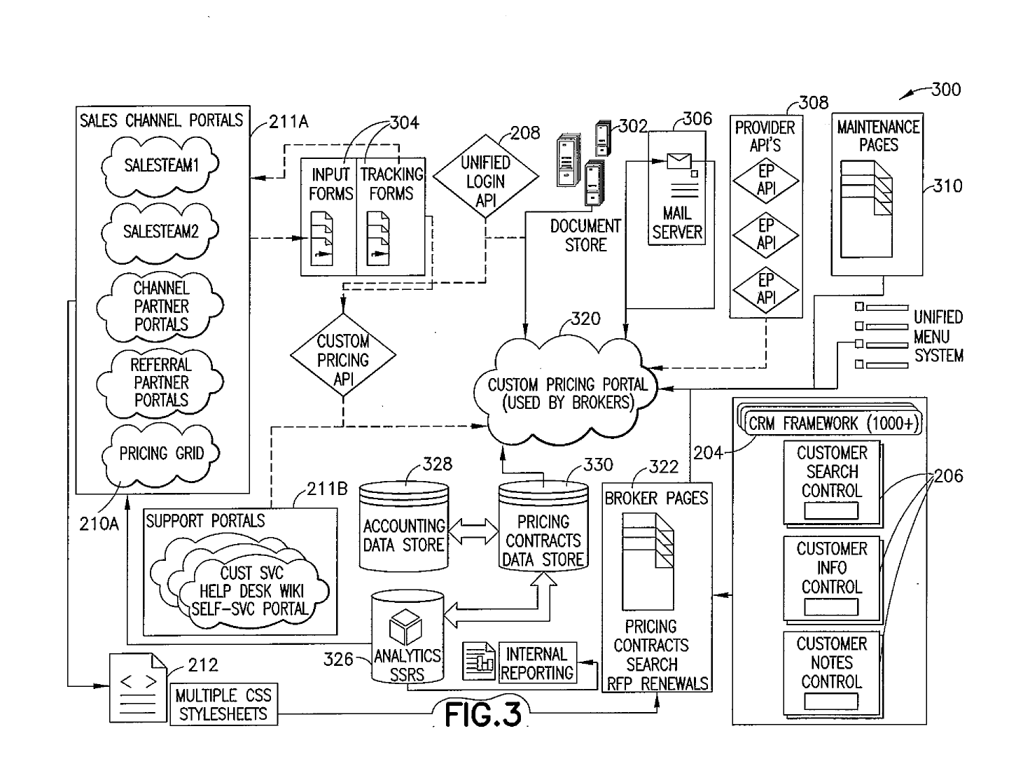

Cascading stylesheets (CSSs) 212 are built from the energy suppliers' own data feeds that provide their respective real-time/near real-time prices and include referring URL's so as to show different brands/icons on different sales channel portals (see 211A of FIG. 3). While there is one engine within the integrated energy broker system that builds the pricing grid or matrix portal 210A that provides the customer with an apples-to-apples comparison respecting units, pricing, contract length and major contract terms, the CSSs 212 enable that same information in the matrix portal 210A to be displayed with different logos, colors and/or styles suitable for different sales units which may be internal or licensed for use by external entities. Whether the pricing grid is displayed at the matrix portal 210A or at the various salesteam or channel partner pricing portals (211A of FIG. 3), certain exceptions might be noted on this/these portals if one or more suppliers require contract provisions that deviate greatly from other suppliers (e.g., a large early-termination penalty).

Generally these real-time or near real-time generic pricing will be less competitive than the customized pricing that the integrated energy broker system can obtain for the larger commercial/industrial customers. These smaller customers whose energy needs are relatively small and more generically categorized can use the customer self-service portal for entering their initial customer information, selecting an energy supplier from among several, and entering into a contract with that selected energy supplier using pricing provided at the pricing grid portal 210A. The customer support portal is used by existing customers to access their account information and history and for contract renewal, including selecting a different energy supplier for the renewal.

The pricing grid portal 201A presents matrix/daily pricing options in an apple-to-apples comparison across several categories, in certain embodiments it may highlight certain more economical choices, but in general it enables the consumer to make the final decision on what pricing fits his/her needs. Once a consumer chooses his/her energy plan (which entails a combination of geographic market, energy type, energy supplier/provider, rate, and term), in certain embodiments the pricing portal 210A will gather all appropriate information from the consumer to create a service contract between the consumer and energy provider, such as by reserving the prospective customer's plan selection and re-directing that customer to the customer self-service portal to enter his/her relevant customer information (name, service and billing addresses, etc.), or creating the contract internally within the portal, passing it through a third-party verification process, and pushing it through the energy provider's API.

For these residential/small business customers the relevant information may then be distributed by the integrated energy broker system as follows:
Through the selected energy provider's API (see FIG. 3) to create the customer and contract in the energy provider's system;
To any third-party customer verification system;
To the CRM application 206;
To the customer self-service portal; and
To the accounting application (FIG. 3) to await electronic reconciliation with the energy provider prior to commission payout;
   The above information distribution completes the process in compliance with PUC regulatory audits and reporting requirements.

One distinct advantage of the pricing grid portal 201A is properly utilizing cascading stylesheets (CSS) 212 and referring URL's to brand the site across several deployments to different sales channels, each of which may utilize its own logo, colors, and styles. Each sales channel, including Independent Sales Agents, may have a personalized website (URL) within the overall integrated energy broker system, and the channel partner portal is an example of one such portal for a third party sales channel but it has the same pricing information as is displayed at the pricing grid portal 210A, ensuring all downstream processes retain that key sales channel and Independent Sales Agent data. Since pricing are likely to differ across different states and utility regions, in an embodiment there will be different such pricing grids and partner portals for each different utility region.

Due to registration/licensure requirements for energy brokers and to provide better relationship management with these energy suppliers, generally all solicitations to the third party energy suppliers are reviewed by the energy broker before being sent, and the energy broker further reviews their responses/proposals before they are presented to end user customers in an aggregated and easily comparable format.

FIG. 3 is a schematic diagram of the overall integrated energy broker system 300. The CRM framework 204, DRM applications 206, cascading stylesheets (CSS) 212 and login API 208 are as previously described. The portals 210 of FIG. 2 are split in FIG. 3 for convenience into sales channel portals 211A which includes the pricing grid 201A and support portals 211B.

The integrated energy broker system 300 includes a document store 302 in which are stored various forms 304 for imputing customer and energy supplier information and for tracking ongoing contracts, offers and proposals. The system 300 may include its own email system 306 and maintenance pages 310 for providing non-programmers a way to change the business rules associated with the different energy providers as they may change their terms and conditions from time to time. There are also energy supplier APIs 308 through which the customized solicitations on behalf of energy using customers are sent out (e.g., via email) to the individual third party energy suppliers, and through which the energy suppliers can provide their offers in reply to the customized solicitations that were sent out to them. These APIs automate the process of manually converting requests for pricing RFP into emails for these energy suppliers, as well as automating the reading and manual entering of their reply quotes into the pricing engine of the integrated energy broker system 300.

There is an accounting data store 328 that tracks payments. In some atypical cases the customers may pay directly to the energy broker company but the more traditional arrangement mentioned above is for the energy agent's commission to be included in the energy pricing quoted to the customer. In that latter case the energy provider then pays the commission to the energy broker company on a periodic/monthly basis once it gets paid for its periodic/monthly supply of energy. However the specific payment arrangement is in these different implementations, it is the accounting data store that tracks amounts due to the energy broker company and from whom they are due and by what date. There are various ways this gross commission is split depending on the specifics of the energy contract and how it was obtained, and the accounting data store 328 tracks such commission splits. For example, gross commissions on contract A may be split among the entity running the integrated energy broker system 300 and an independent sales agent; or if the sales agent is an in-house agent the gross commission amount may be aggregated with others for that agent for bonus computation purposes. And as noted above, this accounting data store 328 flags unacceptable variations among expected and actual commissions per period in case there is some anomaly in what the energy supplier reports as the actual energy used by a given customer for that time period.

The Analytics SQL Server Reporting Services (SSRS) 326 handles mandatory reporting to the PUCs and the archiving data for auditing purposes as well as other internal business intelligence and fiscal analysis.

Different from the pricing grid portal 210A for non-customized energy contracts, the custom pricing portal 320 is used by the energy brokers for activities related to the customized quotes from different energy suppliers that are reflected on the aggregated price comparison sheets the system 300 provides the commercial/industrial customers. This process begins with the customer's authorization for the energy broker to shop for energy contracts on the customer's behalf, which is stored in the CRM database 202 (FIG. 2). The customer may enter this authorization as well as specifics of its energy request at various self-service portals dedicated for this purpose. The broker needs specific information from these large energy use customers such as energy size/volume and rate class in addition to the traditional information of customer name, premises locations, account and meter numbers and invoicing information. Because utility markets are highly segmented even below the granularity of a state, this customer's request is analyzed by a request for pricing wizard software program that filters the customer's request to return only those partner energy providers that are suitable for fulfilling the request (e.g., operate in the customer's utility region, able to satisfy the indicated quantity/volume and contract term for the requested energy type). In the FIG. 3 diagram this request for pricing wizard may be disposed within the pricing grid portal 210A as well as in any of the other salesteam or partner portals. This request for pricing (RFP) wizard also checks all the entered data against several market-specific sets of business logic to ensure all data was entered properly and completely.

Then this information is presented to the appropriate energy broker (as determined by the system logic) in the start of that energy broker's pricing queue chain. The energy broker is presented with all of the available energy providers that serve the customer's utility service area, the appropriate pricing request methods for each of those providers, and any special flags for that provider-market combination.

The system 300 then prepares requests for pricing (RFPs) for each of those qualified third party energy providers which the broker can review at the broker pages 322 prior to them being sent to those energy providers. These RFPs can be generated autonomously by the integrated energy broker system 300 or with the assistance of energy brokers. Through these broker pages the broker can also view the broker's various previous searches to fulfill customer energy requests, pricing information returned by the qualified third party energy providers via their respective API 308 and the custom pricing portal 320, and any existing contracts with the various brokers' customers; all of which are stored in a pricing contract data store 330.

One advantageous aspect of the custom pricing portal 320 is that the RFPs generated by the system are sent to the individual third party energy provider in a format preferred by the respective energy provider, and blind to each other. In one embodiment this is an email and for those energy providers not specifying a provider-specific format there is a default format, but across all of the energy providers that are solicited to bid on a given customer's energy request the RFPs that are sent out from the system 300 are sent in different formats, though in view of the default format option it is not necessary that each RFP be a different format from each other RFP. This enables the individual energy providers to quickly and efficiently provide their bids on the RFP.

Commensurate with the different RFP formats that are sent out to solicit bids, the integrated energy broker system 300 does not require the bids be in the same format, nor that they even quote price in the same units. Another tool in the custom pricing portal is to normalize the units of the pricing received from multiple different energy providers in response to a given customer's request so as to aggregate them on a customer price presentation page under a common energy unit. Regardless of whether the energy provider's bid is entered automatically into the integrated energy broker system 300 via the API 308 and custom pricing portal 320, or entered manually by the broker, the data as entered is in the form provided by the energy supplier. This also simplifies the recordkeeping needed to meet the auditing requirements set by the relevant PUC with regulatory authority over the current deal/customer request since what the energy provider actually sent is automatically archived in the data store 330. As noted above, while for electricity it is common for providers to quote prices in kWh, it is not universal and for commercial/industrial customers it is not always bid on per-kWh pricing but it is sometimes bid on an index or block pricing. In the natural gas energy supply market there is even less commonality among bids from different energy providers in that often the different bids will be in pricing units that are not readily convertible such as therms/BTUs versus gas volume (typically CCF).

When the customer chooses a provider-term-rate combination that meets his/her needs, the record is moved into the contracts queue chain, where the contract preparation wizard (within the pricing contracts data store 330) guides the energy broker through the steps for that particular provider-market-product-size combination. After receiving the signed contract from the customer, the contract booking wizard ensures all steps are taken to complete the transaction, including steps for accounting purposes and other tracking information.

In certain embodiments the custom pricing portal 320 will run concurrently with the pricing grid portal 210A in an integrated manner with a common internal framework, which may include the following features.
A unified login system which controls page, data, and functional permissions for users across all companies and tasks within all internal portals.
A unified menu system which allows access to numerous, separate internal portal pages from within a single integrated environment.
A customer relationship management (CRM) application for all companies, allowing Sales Managers, Account Executives, and Independent Sales Agents to track and mass market (through email, text, and social media) to a particular segment of consumers.
A custom and matrix/daily pricing engine producing apple-to-apples comparisons, automated contract preparation, tracking, and transmittal to energy provider for commercial customers.
An accounting system to track and reconcile customer accounts, usage, and income.
A SQL Server Reporting Services (SSRS) interface for staff and management to real-time query (with appropriate permissions) customer, sales, volume, income, and usage data across all companies through canned reports and ad-hoc query builders.
A Wiki/Help system employing tool tip and video features within the software to assist end users based on his/her current page location.

This framework can be published to multiple portals, each branded appropriately. The different sales teams/sales companies can then utilize a back-office portal branded with appropriate logo, colors, and styles, published to its own domain thereby enabling each portal to display a unique appearance despite running the same software engine. Additionally, staff using internal account portals (accounting, pricing, and contract management) will have each account screen displayed using the theme of the account-owning team/company. To complete the internal user experience, this application framework can be integrated with a network marketing web application so as to serve the following functions:
To serve the self-replicated marketing pages that refer customers to the pricing grid portal publications;
To manage an Independent Sales Agent's personal network, including communication tools; and
To produce commissions based on sales pushed through its API from the internal accounting application, and the distributor hierarchy within the software.

The network marketing software can be integrated with the internally developed software, accessed through the unified login and menu system, and passing data back and forth via API's. This tight integration will give the independent sales agents a seamless experience between the two software suites.

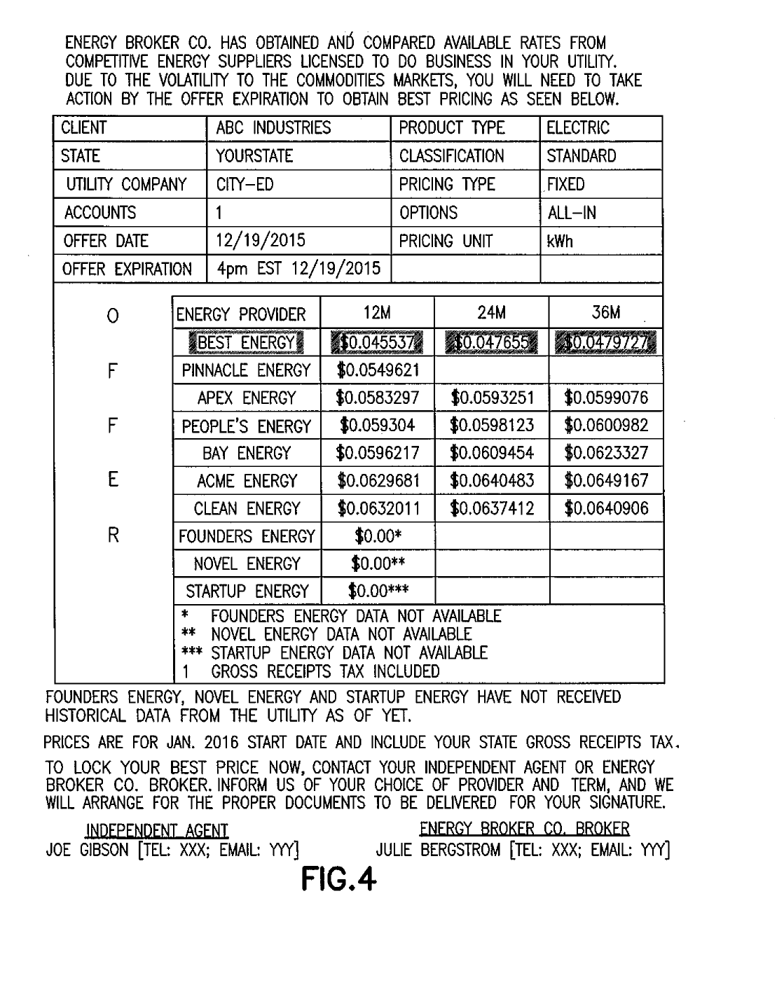

FIG. 4 is a non-limiting example of an aggregated price comparison sheet provided to commercial/industrial customers and having customized prices in a normalized pricing unit that may be automatically generated by the integrated energy broker system 300 described above. The custom pricing engine (portal 320) found ten suitable energy providers, all of which are listed thereon but the last three listed have no corresponding price due to various reasons, one of which may simply be they did not return a bid prior to the deadline established by the system 300 and sent out with the RFPs. The listed utility company will provide energy delivery services through its infrastructure, the pricing type and units are normalized across all bids as represented at the upper right of the FIG. 4 sheet, and the offer expiration is on the same date as the date this offer is presented to the prospective customer.

For convenience the bids are listed in order of lowest to highest for the shortest term listed, and the lowest bid per unit price is highlighted, with the option for an energy broker to change the order or highlight favorable terms at his/her discretion. Even without these the straightforward apples-to-apples comparison on this sheet makes the customer's informed evaluation of his/her energy supply options much more efficient than conventional procedures for soliciting energy customers. The display at the Pricing Grid portal 210A can show similar information in tabular format for the non-customized needs of residential and small business customers, with different such portals 210A for each different utility region.

The aggregated price comparison sheet shown by example at FIG. 4 may be a printed sheet, or preferably due to the short expirations they generally require it may be sent in electronic form to the customer or presented at the customer API upon the customer's online request to see it. In the latter embodiment the energy brokerage system may send the customer a notification (phone, email, text, etc.) that the sheet is now ready for his/her review. In one particular embodiment the customer's selection (e.g., electronically ‘clicking’ on) of a particular price, energy provider or other such entry in the emailed or texted aggregated price comparison sheet acts as the customer's choosing of that particular offer (in some embodiments this may be self-confirming or a further confirmation such as a yes/no choice may be required). Selection of a particular offer on the aggregated price comparison sheet on the customer's own electronic device (desktop, laptop, tablet, smartphone, etc.) then automatically begins the contract preparation process back at the integrated energy broker system 300, which can further automatically send the contract to the customer after final review by an energy broker if the controlling PUC requires such a review.

The description above and the aggregated price comparison sheet shown by non-limiting example at FIG. 4 are relatively straightforward in that one energy supplier provides a quote for all the energy needs of one customer. While this may be typical for residential/small business energy customers, it is not unusual for commercial/industrial energy customers to have multiple meters or points of service spread across multiple utility areas and/or across multiple types of energy. For example, company Q needs electrical service at 17 meters and gas service at 4 meters located at a corporate campus within utility region B and this same company Q also needs electrical service at 42 meters and gas service at 14 meters at a manufacturing facility located 40 miles away within utility region C. It is not unusual for a single commercial/industrial customer in the US to have 100 or more distinct service locations/meters. Not all of the energy suppliers serving regions B and C will supply both electric and gas, and not all of the energy providers supplying both natural gas and electricity will serve both regions B and C. In such complex energy supply scenarios the integrated energy broker system 300 enables substantial efficiencies over conventional practice by providing multi-location and cross-utility/energy type aggregated pricing.

In such complex pricing scenarios the agent, using the system 300, is able to easily group all of the locations by utility, and the system 300 will create multiple RFP's for each customer—one RFP for each group of locations that fall within a given utility region, and one RFP for each energy type within each of those utility regions. The integrated energy broker system 300 will then request and track pricing on all of those groupings and energy types separately, while still keeping them all easily associated with the single customer. Conventionally energy brokers would typically request pricing from only those providers that handle all of the service areas (which limits the number of competitive prices), and those few providers would provide an aggregate price for all of the locations. To the contrary, the integrated energy broker system 300 is able to obtain more favorable pricing for the commercial/industrial customer by systematically dividing the requests up by utility region and by utility type. Since energy pricing varies greatly by utility even within each third party provider, this almost always inures to a more competitive price being made available to the customer as compared to conventional manual energy broker practice.

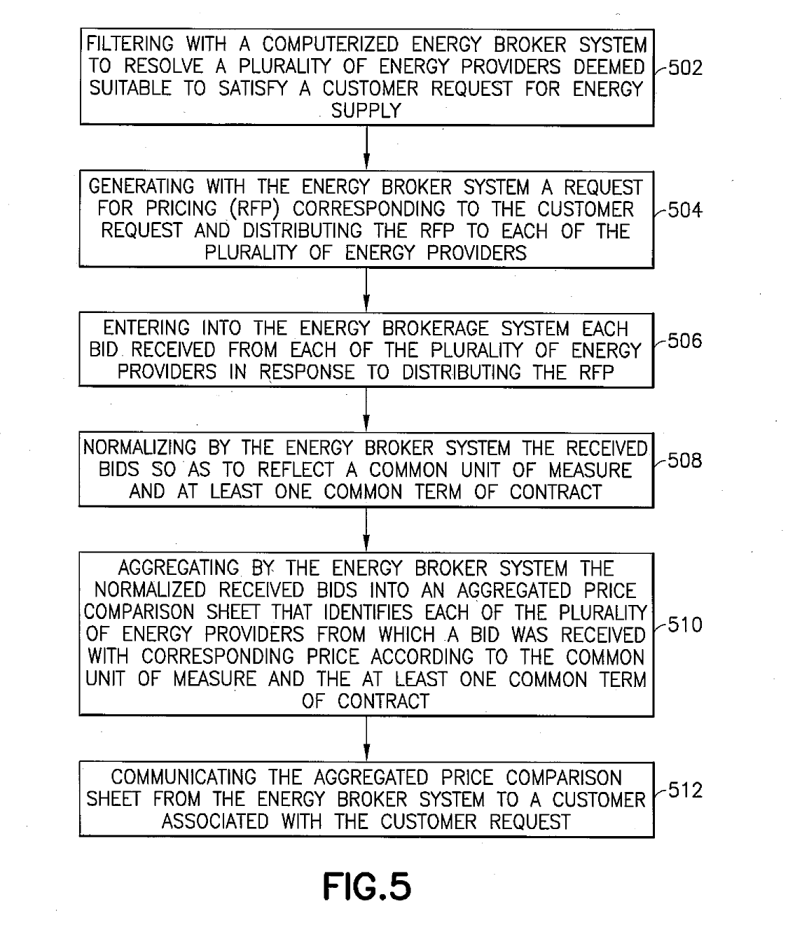

FIG. 5 is a process flow diagram summarizing some of the steps described above that are performed by or with the integrated energy broker system. In this regard FIG. 5 may be considered to represent a method for operating a computerized energy broker system, or functional description of different computer program software code, according to certain aspects of these teachings. At block 502 the energy broker system filters to resolve a plurality of energy providers deemed suitable to satisfy a customer request for energy supply. Then at block 504 the energy broker system generates a request for pricing (RFP) corresponding to the customer request and distributing the RFP to each of the plurality of energy providers. Block 506 has each bid that was received from each of the plurality of energy providers in response to distributing the RFP entered into the energy brokerage system. As mentioned above this entry may be done manually or it may be automatically entered into the system via the energy provider's API. The energy broker system normalizes the received bids so as to reflect a common unit of measure and at least one common term of contract at block 508; and at block 510 it aggregates the normalized received bids into an aggregated price comparison sheet such as that shown by example at FIG. 4 that identifies each of the plurality of energy providers (at least those from which a bid was received) with corresponding price according to the common unit of measure and the at least one common term of contract. In FIG. 4 the common unit of measure was kWh and the common contract term was 12 months, and also 24 months and 36 months. Finally at block 512 the aggregated price comparison sheet is communicated from the energy broker system to a customer who is associated with the customer request.

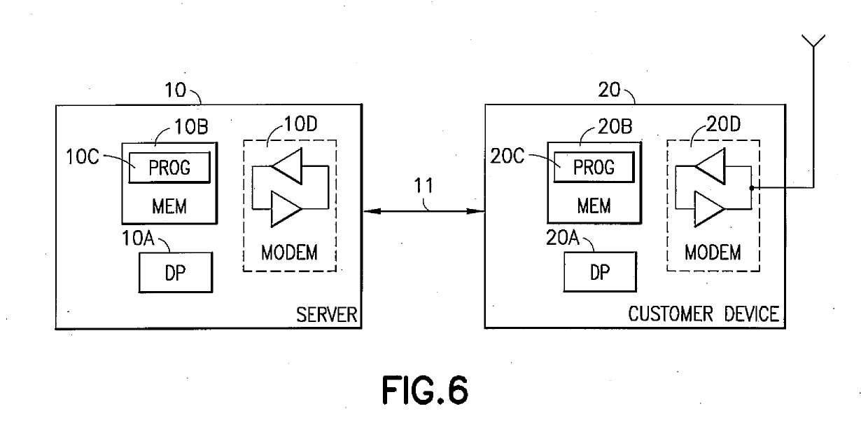

Various aspects detailed above may be practiced individually or in any of various combinations. FIG. 6 is a schematic diagram illustrating some components of a server 10 of which one or more may host the energy broker system as described herein, and also a customer device 20 at which a customer might receive notifications or an email with the aggregated price comparison sheet described herein.

The server 10 includes a controller, such as a computer or a data processor (DP) 10D, a computer-readable memory medium embodied as a memory (MEM) 10B that stores a program of computer instructions (PROG) 10C, and a suitable wired or wireless interface that includes a modem 10D for bidirectional communications with external entities via the Internet or an extranet. There may further be one or more externally connected graphical display monitors and user interfaces such as keyboards, mice, glidepads, gesture and voice recognition devices and the like.

The link 11 between the server 10 and the customer device 20 will typically not be direct as shown but the specific infrastructure of the linking network is not germane to the inventive aspects of these teachings and so is not shown. The customer device 20 also includes a controller, such as a computer or a data processor (DP) 20A, a computer-readable memory medium embodied as a memory (MEM) 20B that stores a program of computer instructions (PROG) 20C, and a suitable wireless interface, such as a modem 20D which for some customer devices may be incorporated with a radiofrequency transmitter/receiver combination for communication with the server 10 via one or more antennas and a wireless network. There is a graphical user interface at the customer device 20 at which the aggregated price comparison sheet may be tangibly displayed.

At least one of the PROGs 10C/20C is assumed to include program instructions that, when executed by the associated DP 10A/20A, enable the host device to operate in accordance with exemplary embodiments of this invention as detailed above. That is, various exemplary embodiments of this invention may be implemented at least in part by computer program/software that is executable by the DP 10A of the server 10; by the DP 20A of the customer device 20, or by hardware or by a combination of software and hardware (and firmware).

In various exemplary embodiments the server 10 and/or the customer device 20 may also include dedicated processors. There may also be one or more modules that is/are specifically constructed so as to operate in accordance with various exemplary embodiments of these teachings.

The computer readable MEMs 10B/20B may be of any type suitable to the local technical environment and may be implemented using any one or more suitable data storage technology, such as electronic memory devices that may be semiconductor based memory, flash memory, magnetic memory, and/or optical memory devices. Whether electronic or optical, the memory device may be embodied as a portable computer diskette, a hard disk, a random access memory (RAM), a read-only memory (ROM), an erasable programmable read-only memory (EPROM or Flash memory), a portable compact disc read-only memory (CD-ROM) which may be electronic or optical, or any suitable combination of the foregoing.

The DPs 10A/20A may be of any type suitable to the local technical environment, and may include one or more of general purpose computers, special purpose computers, microprocessors, digital signal processors (DSPs) and processors based on a multicore processor architecture, as non-limiting examples. The communication interfaces (e.g., the modems 10D/20D) may be of any type suitable to the local technical environment and may be implemented using any suitable communication technology such as individual modems, wireless transmitters, wireless receivers, transceivers or a combination of such components.

In general, the various embodiments of the customer device 10 can include, but are not limited to, desktop laptop and tablet computers, smart phones and other such cellular telephones, personal digital assistants (PDAs), and Internet appliances. Any of these may be embodied as a fixed device (e.g., desktops), a portable device, a wearable device, a device that is implanted in whole or in part, a vehicle-mounted communication device, and the like.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into an embodiment that is not specifically detailed herein as separate from the others. Accordingly, the description is intended to embrace all such alternatives, modifications and variances which fall within the scope of the appended claims.

What is claimed is:

1. A method for operating a computerized energy broker system, the method comprising:
filtering with the energy broker system to resolve a plurality of energy providers deemed suitable to satisfy a customer request for energy supply;
generating with the energy broker system a request for pricing (RFP) corresponding to the customer request and distributing the RFP to each of the plurality of energy providers;
entering into the energy brokerage system each bid received from each of the plurality of energy providers in response to distributing the RFP;
normalizing by the energy broker system the received bids so as to reflect a common unit of measure and at least one common term of contract;
aggregating by the energy broker system the normalized received bids into an aggregated price comparison sheet that identifies each of the plurality of energy providers from which a bid was received with corresponding price according to the common unit of measure and the at least one common term of contract; and
communicating the aggregated price comparison sheet from the energy broker system to a customer associated with the customer request.

2. The method according to claim 1, wherein distributing the RFP to each of the plurality of energy providers is conditional on approval by an energy broker that is registered and/or licensed for a same utility area in which is located customer premises that is subject to the customer request.

3. The method according to claim 2, wherein communicating the aggregated price comparison sheet is also conditional on approval by such an energy broker.

4. The method according to claim 1, wherein for each of the plurality of energy providers which have specified a preferred RFP format, the generated RFP is distributed to each respective said energy provider in the respectively specified format.

5. The method according to claim 1, wherein each bid received from each of the plurality of energy providers is entered into the energy brokerage system exactly as received from the respective energy provider.

6. The method according to claim 1, further comprising, in response to the energy broker system receiving an input selecting an energy provider and term of contract from the aggregated price comparison sheet, at least one of:
the energy broker system generating a contract between the customer and the selected energy provider for the selected term and presenting the generated contract to the customer; and
the energy broker system re-directing the customer to a website operated by the selected energy provider and providing the selected energy provider with information of the selected term of contract.

7. The method according to claim 6, further comprising:
from the selected term of contract, determine a contract termination date and send to the customer or to a sales agent a reminder to renew at least one month prior to the contract termination date.

8. The method according to claim 1, wherein the customer request for energy supply is for locations in at least a first utility region and a second utility region;
the generating comprises generating with the energy broker system a first RFP corresponding to all the locations within the first utility region and a second RFP corresponding to all the locations within the second utility region; and
the distributing comprises distributing the first RFP to those energy providers that service the first utility region and distributing the second RFP to those energy providers that service the second utility region.

9. The method according to claim 8, wherein the customer request for energy supply is for natural gas and for electricity at locations in at least the first and second utility regions, and
the generating comprises generating different RFPs for natural gas and for electricity for corresponding locations in each of the first and second utility regions.

10. A computer readable memory tangibly storing computer program code that when executed by one or more processors causes a host device to at least:
filter to resolve a plurality of energy providers deemed suitable to satisfy a customer request for energy supply;
generate a request for pricing (RFP) corresponding to the customer request and distributing the RFP to each of the plurality of energy providers;
enter each bid received from each of the plurality of energy providers in response to distributing the RFP;
normalize the received bids so as to reflect a common unit of measure and at least one common term of contract;
aggregate the normalized received bids into an aggregated price comparison sheet that identifies each of the plurality of energy providers from which a bid was received with corresponding price according to the common unit of measure and the at least one common term of contract; and
communicate the aggregated price comparison sheet to a customer associated with the customer request.

11. The computer readable memory according to claim 10, wherein distributing the RFP to each of the plurality of energy providers is conditional on approval by an energy broker that is registered and/or licensed for a same utility area in which is located customer premises that is subject to the customer request.

12. The computer readable memory according to claim 11, wherein communicating the aggregated price comparison sheet is also conditional on approval by such an energy broker.

13. The computer readable memory according to claim 10, wherein for each of the plurality of energy providers which have specified a preferred RFP format, the generated RFP is distributed to each respective said energy provider in the respectively specified format.

14. The computer readable memory according to claim 10, wherein each bid received from each of the plurality of energy providers is entered into the host device exactly as received from the respective energy provider.

15. The computer readable memory according to claim 10, further comprising, in response to the host device receiving an input selecting an energy provider and term of contract from the aggregated price comparison sheet, at least one of:
the host device generating a contract between the customer and the selected energy provider for the selected term and presenting the generated contract to the customer; and
the host device re-directing the customer to a website operated by the selected energy provider and providing the selected energy provider with information of the selected term of contract.

16. The computer readable memory according to claim 15, further comprising:
from the selected term of contract, determine a contract termination date and send to the customer or to a sales agent a reminder to renew at least one month prior to the contract termination date.

17. The computer readable memory according to claim 10, wherein the customer request for energy supply is for locations in at least a first utility region and a second utility region;
the generating comprises generating with the energy broker system a first RFP corresponding to all the locations within the first utility region and a second RFP corresponding to all the locations within the second utility region; and
the distributing comprises distributing the first RFP to those energy providers that service the first utility region and distributing the second RFP to those energy providers that service the second utility region.

18. The computer readable memory according to claim 17, wherein the customer request for energy supply is for natural gas and for electricity at locations in at least the first and second utility regions, and
the generating comprises generating different RFPs for natural gas and for electricity for corresponding locations in each of the first and second utility regions.

19. A computing device comprising:
at least one memory storing computer program code; and
at least one processor,
wherein the at least one processor is configured, with the at least one memory and the computer program code, to cause the computing device to at least:
filter to resolve a plurality of energy providers deemed suitable to satisfy a customer request for energy supply;
generate a request for pricing (RFP) corresponding to the customer request and distributing the RFP to each of the plurality of energy providers;
enter each bid received from each of the plurality of energy providers in response to distributing the RFP;
normalize the received bids so as to reflect a common unit of measure and at least one common term of contract;
aggregate the normalized received bids into an aggregated price comparison sheet that identifies each of the plurality of energy providers from which a bid was received with corresponding price according to the common unit of measure and the at least one common term of contract; and
communicate the aggregated price comparison sheet to a customer associated with the customer request.

20. The computing device according to claim 19, wherein the customer request for energy supply is for locations in at least a first utility region and a second utility region;
the generating comprises the computing device generating a first RFP corresponding to all the locations within the first utility region and generating a second RFP corresponding to all the locations within the second utility region; and
the distributing comprises the computing device distributing the first RFP to those energy providers that service the first utility region and distributing the second RFP to those energy providers that service the second utility region.
